(19) United States
(12) Patent Application Publication
(10) Pub. No.: US 2018/0025332 A1
(43) Pub. Date: Jan. 25, 2018

(54) TRANSACTION FACILITATION

(71) Applicant: MasterCard Asia/Pacific Pte. Ltd., Singapore (SG)

(72) Inventors: Donghao Huang, Singapore (SG); Naman Aggarwal, Singapore (SG); Kshama Jha, Singapore (SG); Yong How Chin, Singapore (SG); Jie Zhang, Singapore (SG); Dekai Zhang, Singapore (SG)

(21) Appl. No.: 15/627,793

(22) Filed: Jun. 20, 2017

(30) Foreign Application Priority Data
Jul. 20, 2016 (SG) 10201605974Y

(51) Int. Cl. G06Q 20/10; H04L 29/06; G06Q 20/38; H04L 9/08; G06Q 20/32; G06Q 20/40

(52) U.S. Cl. CPC G06Q 20/10; G06Q 20/325; G06Q 20/322; G06Q 20/40; G06Q 20/3829; H04L 9/083; H04L 63/062

(57) ABSTRACT

A system for facilitating a payment using a client application executed by a client device, the system including one or more processing devices in communication with the client device via a communications network, wherein the one or more processing devices execute processing device software that cause the one or more processing devices to communicate with the client application to establish a transaction session having a session access token and a session key, receive requests from the client application, at least some of the requests including the access token a payload encrypted at least in part using the session key, decrypt the payload at least in part using the session key, process the requests at least in part using the access token and in accordance the decrypted payload, to thereby allow at least one action to be performed, the at least one action forming part of a payment process and provide any required response to the client application.

### CROSS-REFERENCE TO RELATED APPLICATION

This application is a U.S. National Stage filing under 35 U.S.C. §119, based on and claiming benefit of and priority to SG Patent Application No. 10201605974Y filed Jul. 20, 2016.

### BACKGROUND OF THE INVENTION

The present invention relates to a method and system for facilitating a transaction and in one example, to a method and system for facilitating a payment using a client application executed by a client device.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The use of mobile applications for facilitating payments is known. However, such applications are typically created on a case by case basis for particular service providers, and creating such applications can be problematic, requiring a significant amount of resources in ensuring the application is able to interact with the service provider's existing payment systems and to ensure an adequate level of security is afforded.

### SUMMARY OF THE PRESENT INVENTION

There is provided a system for facilitating a payment using a client application executed by a client device, the system including one or more processing devices in communication with the client device via a communications network, wherein the one or more processing devices execute processing device software that cause the one or more processing devices to: (a) communicate with the client application to establish a transaction session having: (i) a session access token; and, (ii) a session key; (b) receive requests from the client application, at least some of the requests including the access token; (c) process the requests at least in part using the access token, to thereby allow at least one action to be performed, the at least one action forming part of a payment process; and, (d) provide any required response to the client application. The system is preferably used for making peer-to-peer payments.

Preferably, the requests from the client application further including an encrypted payload, the payload being encrypted at least in part using the session key.

It is preferable that the one or more processing devices execute processing device software that further cause the one or more processing devices to decrypt the payload at least in part using the session key.

The one or more processing devices can preferably, (a) receive a request; (b) validate the access token associated with the request; and (c) selectively perform actions in accordance with an outcome of the validation.

Preferably, the one or more processing devices: (a) receive a session initiation request from the client application including: (i) a device identifier of the client device; and, (ii) a public session key generated by the client application; (b) generate an access token; and, (c) provide a session initiation response to the client application including a processing device public key and the access token.

It is preferable that the one or more processing devices store session data including an indication of the device identifier and the access token.

The one or more processing devices can preferably validate the access token by comparing at least one of the access token and the device identifier associated with a request to the session data.

The one or more processing devices can preferably: (a) generate a refresh token; and, (b) provide a session initiation response including the refresh token.

It is preferable that the client application: (a) determines if the access token has expired; and, (b) if the access token has expired, provides an access token request including a refresh token to the one or more processing devices, the one or more processing devices being responsive to the access token request to: (i) validate the refresh token; (ii) generate a new access token in accordance with an outcome of the validation; and, (iii) provide an access token response including the new access token to the client application.

Preferably, the one or more processing devices: (a) determine if authentication has been performed; (b) selectively perform actions depending on an outcome of the determination; (c) receive an authentication request, the authentication request being generated by the client application at least partially in accordance with authentication information provided by a user; and, (d) selectively perform authentication using the authentication request, the authentication being performed by comparing the authentication information to previously stored authentication information.

It is preferable that the one or more processing devices stores an indication of an authentication status associated with the access token.

Preferably, the one or more processing devices: (a) determine the access token associated with a request; and, (b) determine if authentication has been performed at least partially in accordance with an authentication status associated with the access token.

It is preferable that the session key includes a public session and a private session key of a session key pair, the session key pair being generated for each transaction session by the client application. Each payload can be encrypted and decrypted using a one-time symmetric key derived using the session key.

It is preferable that each one-time symmetric key is generated using: (a) an initialisation vector; and, (b) at least one of: (i) a private session key and a processing device public key; (ii) a public session key and a processing device private key.

It is also preferable that the client application: (a) generates an initialisation vector; (b) generates a one-time symmetric key using the initialisation vector, the private session key and the processing device public key; (c) encrypts a payload using the symmetric key to generate an encrypted payload; and, (d) provides a request including the encrypted payload and the initialisation vector, and wherein the one or more processing devices are responsive to the request to: (i) generate the one-time symmetric key using the received initialisation vector, the public session key and the processing device private key; and, (ii) use the one-time symmetric key to decrypt the encrypted payload.

Preferably, the one or more processing devices: (a) generate an initialisation vector; (b) generate the one-time symmetric key using the initialisation vector, the public session key and the processing device private key; (c) encrypt a payload using the symmetric key to generate an encrypted payload; and, (d) provide a response including the encrypted payload and the initialisation vector, the client application being responsive to the response to: (i) generate the one-time symmetric key using the received initialisation vector, the private session key and the processing device public key; and, (ii) use the one-time symmetric key to decrypt the encrypted payload.

It is preferable that the processing device software is middleware that interfaces with a payment system. The processing device software can also provide the client application with access to supported features of the payment system.

The payment system can be at least one of: (a) a payment gateway; and, (b) a payment system implemented by a payment service provider.

Preferably, the processing device software is an API to the payment system, and wherein the requests and responses correspond to API calls.

In another aspect, there is provided a payment method for facilitating a payment using a client application executed by a client device and one or more processing devices in communication with the client device via a communications network, whereby the one or more processing devices execute processing device software, and whereby the method includes causing the one or more processing devices to: (a) communicate with the client application to establish a transaction session having: (i) a session access token; and, (ii) a session key; (b) receive requests from the client application, each request including the access token; (c) process the requests to thereby allow at least one action to be performed in accordance with the requests, the at least one action including causing a payment to be performed; and, (d) provide any required response to the client application, each request including a payload encrypted at least in part using the session key.

Preferably, the requests from the client application further including an encrypted payload, the payload being encrypted at least in part using the session key.

The method can further cause the one or more processing devices to decrypt the payload at least in part using the session key.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:—

FIG. 1 is a flow chart of an example of a method of facilitating a transaction;

FIG. 2 is a schematic diagram of an example of a distributed computer architecture;

FIG. 3 is a schematic diagram of an example of a base station processing system;

FIG. 4 is a schematic diagram of an example of a client device of FIG. 2;

FIGS. 5A to 5E are a flowchart of an example of a specific example of a method of facilitating a transaction;

FIG. 6A is a flow chart of an example of a process for configuring authentication information;

FIG. 6B is a flaw chart of an example of an example of an authentication process;

FIG. 7A is a schematic diagram of an example of a session initialisation process;

FIG. 7B is a schematic diagram of an example of a messaging process; and,

FIG. 7C is a schematic diagram of an example of an access token refresh process.

### DETAILED DESCRIPTION OF THE PREFERRED EMBODIMENTS

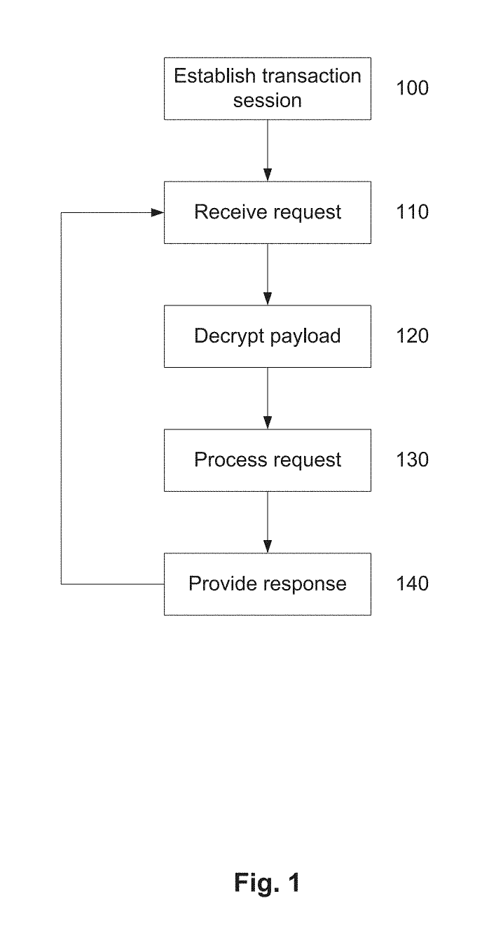

An example of a process for facilitating a transaction will now be described with reference to FIG. 1.

For the purpose of illustration, it is assumed that the process is performed at least in part using one or more electronic processing devices forming part of one or more processing systems, such as servers, which are in turn connected to one or more client devices, such as mobile phones, portable computers or the like, via a network architecture, as will be described in more detail below.

For the purpose of this example, it is further assumed that the client device is executing a client application and that the one or more processing devices execute processing device software. Whilst these could be of any form, in one example, these include a mobile application executed by a mobile device, such as a phone or tablet, and supporting middleware implemented on one or more servers, that configures the client application, allowing supported features to be enabled, the supported features including, for example, electronic fund transfer services, banking services, and so forth.

In use, at step 100, the one or more processing devices communicate with the client application to establish a transaction session. In this regard, each transaction session is associated with an access token and a session key, which are used in order to allow the session to be implemented securely. This process can be performed in any suitable manner and typically includes one or more messages being transferred between the client application and the one or more processing devices, for example by having the client application request initialisation of the session and provide the session key, and having the one or more processing devices respond with responses including the necessary tokens, as will be described in more detail below.

At step 110, the one or more processing devices receive requests from the client application, the requests including the access token and where necessary, an encrypted payload. The encrypted payload is generated by encrypting a payload at least in part using the session key, and in one preferred example, using a one-time symmetric key derived from the session key. The request is typically generated based on user interaction with the client application, for example to call functions made available by the processing device software based on user selections.

At step 120, the one or more processing devices decrypt the payload at least in part using the session key, for example using the one-time symmetric key, which can again be derived from the session key.

The one or more processing devices then process the request at step 130, at least in part using the access token and optionally in accordance with any decrypted payload, to thereby allow at least one action to be performed. This process will typically include validating the access token, and then performing one or more predefined actions based on the nature of the received request and any relevant data provided in the payload.

The actions typically relate to one or more parts of a payment process, so that a sequence of actions can be used to allow a payment, such as a peer-to-peer payment, to be performed. Whilst the actions could be performed by the one or more processing devices, and the processing device software executed thereon, more typically the actions are performed by a payment system, such as a payment gateway, or payment system hosted by a service provider, as will be described in more detail below.

At step 140, the one or more processing devices can provide any required response to the client application. Such responses can optionally include an encrypted payload, depending on the response requirements. Thus, for example, the responses could be confirmation that the request has been received and processed, requests for information that is required in order for actions to be performed, options for further available or required actions, or the like.

The steps 110 to 140 can then be repeated as required, allowing a sequence of actions to be performed in order to allow payments to be made.

The above described system therefore provides a client application and processing device software that interact, allowing sequences of actions to be performed. This in turn can provide a number of benefits over existing systems.

In particular, in the above arrangements, features of the system are made available by the processing device software. This enables required features to be implemented and selectively enabled at a server level, so as to simplify operation of the client application executed on the client device.

Furthermore, in one example, the processing device software can be implemented as middleware, which acts as an API (Application Programming Interface) between the client application and an underlying payment system, such as a payment gateway, financial institution system or the like. Accordingly, this allows existing payment systems to be used in order to make payments using the client applications.

This in turn allows the arrangement to be used by service providers that cannot provide facilities for payments, such as peer-to-peer payments, within their existing systems. In particular, the processing device software can be deployed in order to provide an interface into the payment system, which might not have an existing accessible front end, allowing this to be accessed via the client application. As the middleware can be adapted to interface with a wide variety of existing payment systems, this allows service providers to leverage their existing payment systems with readily configurable middleware in order to provide a mobile or other client device based payment system. Furthermore, as the majority of functionality is implemented at the middleware level, the client applications can be easily configured so that these are customised to the respective service provider, thereby allowing service providers to provide customised payment systems with minimal custom programming.

Despite the flexibility and ease of use provided with the above described arrangements, the particular security arrangements, and in particular the use of tokens and session keys, can be used to ensure a high level of security, thereby preventing fraudulent use of the system, even in the face of the reuse of significant client application and processing device software code.

A number of further features will now be described.

In one example, access to the processing device software is controlled on a per session basis using access tokens, with actions only being performed once access tokens provided with a request have been validated. In this example, when receiving a request from the client application, the one or more processing devices will validate the access token associated with the request and selectively perform actions in accordance with an outcome of the validation. The validation will typically involve checks, such as ensuring the access token has not expired, is of a defined form, was issued for the current session, and was issued to the client device sending the request.

In this regard, the access tokens are typically established during a session initialisation process. This could be achieved in any suitable manner, but typically includes the one or more processing devices receiving a session initiation request from the client application, the session initiation request including a device identifier of the client device and a public session key generated by the client application. The one or more processing devices are responsive to the session initiation request to generate an access token and provide a session initiation response to the client application including a processing device public key and the access token.

Through this process, the access token can be uniquely associated with a device identifier of the client device, such as a MAC (Media Access Control) address or other unique identifier. This can be achieved by storing session data including an indication of the access token and the device identifier, allowing this to be used to be used in validating the subsequent use of the access token by client application. In particular, the processing device software can compare a device identifier and access token associated with a request to the session data, validating the access token if the device identifier and access token match those recorded in the session data. Thus, the one or more processing devices compare received access tokens against the session data to ensure the access token was issued by the processing devices for the current session, and optionally comparing the device identifier of the client device sending the request with the indication of the device identifier stored in the session data, ensuring these also match.

In one example, the access tokens can have a limited lifespan, in which case the one or more processing devices may also generate a refresh token and provide this to the client application as part of the session initiation response. In this instance, validation can include ensuring the access tokens have not expired. In the event an expired access token is received, the respective request will not be actioned. In order to avoid this, before generating a request, the client application determines if the access token has expired and if the access token has expired provides an access token request including a refresh token to the one or more processing devices. The one or more processing devices are responsive to the access token request to validate the refresh token, for example using similar approaches to those discussed above, generating a new access token and providing this to the client application in response to a successful validation.

By only allowing actions to be taken upon provision of a valid access token, limited to the relevant client device, and by time limiting the life span of the access tokens, this can help prevent interception of tokens being used in order to allow third party devices to access functions of the processing device software.

Typically, the one or more processing devices determine if authentication has been performed and selectively perform actions depending on an outcome of the determination. In this regard, the actions that can be performed are typically limited in nature until authentication has been performed in order to prevent unauthorised actions, such as payments, being performed.

Authentication can be performed in any suitable manner but is typically performed by having the one or more processing devices receive an authentication request generated by the client application at least partially in accordance with authentication information provided by a user, selectively perform authentication using the authentication request, for example by comparing received authentication information to previously stored authentication information, and recording an indication of an authentication status associated with the access token, for example as part of the session data.

The authentication information could be of any suitable form and could include biometric information, a unique identifier, such as a PIN (Personal Identification Number), password, or the like, or information derived therefrom, such as a hashed or encrypted PIN.

Whilst the authentication process could include having the client application perform authentication using the authentication information, and then only generate the authentication request in response to a successfully authentication, more typically, this is performed by the processing device software, thereby limiting the degree of complexity required by the client application.

Authentication is typically performed on a per session basis, so at some stage during a session, assuming authentication is required, the client application will generate an authentication request least partially in accordance with authentication information provided by the user. The authentication request is provided to the one or more processing devices, which selectively perform authentication using the authentication request. In particular, the one or more processing devices perform authentication by comparing the authentication information to authentication information previously stored, for example during a setup process, as will be described in more detail below. An outcome of the authentication process can then be stored as an indication of an authentication status associated with the access token.

Thus, when a user enters a session, or the first time in a session an action requiring authentication, the user can undergo authentication, with this being stored against the access token, for example as part of the session data. Accordingly, when subsequently receiving a request, the one or more processing systems can use the access token associated with the request to determine if authentication has been performed at least partially in accordance with an authentication status associated with the access token.

Thus, in the above described process, authentication is therefore typically performed by the one or more processing devices on a per session basis, with an authentication status being recorded against the access token for the respective session. As authentication information is only ever transferred as part of a request, such as a set-up or authentication request, this allows the authentication information to be transmitted as an encrypted payload, thereby preventing this being intercepted and used by third parties. This arrangement avoids the need for the client application stored on the client device to implement authentication capabilities, whilst still ensuring security of the overall process is maintained.

As previously mentioned, payloads can be encrypted as required, with the encryption being at least partially based on a session key, which is unique to the current session. The session key can be of any appropriate form, but in one example includes a public session and a private session key of a session key pair, the session key pair being generated for each transaction session by the client application. By generating the session key for each session, this avoids the need for the client application to securely store a key, and adds further security by ensuring intercepted keys cannot be used in subsequent sessions.

In the current example, rather than using the session key to encrypt data directly, instead each payload is encrypted and decrypted using a one-time symmetric key derived using the session key. In one example, this is achieved by generating the one-time symmetric key using an initialisation vector and at least one of a private session key and a processing device public key or a public session key and a processing device private key. This allows the client application and the one or more processing devices to exchange public keys at the start of each session, and then use an initialisation vector each time a payload is to be encrypted, allowing one-time symmetric keys to be generated for payload encryption/decryption using the initialisation vector and the public and private keys.

Thus, when generating a request, the client application generates an initialisation vector and then generates a one-time symmetric key using the initialisation vector, the private session key and the processing device public key. The client application encrypts a payload using the symmetric key to generate an encrypted payload and provides a request including the encrypted payload and the initialisation vector to the one or more processing devices. The processing devices then generate the same one-time symmetric key using the received initialisation vector, the public session key and the processing device private key, using the one-time symmetric key to decrypt the encrypted payload.

Similarly, when generating responses, the one or more processing devices generate an initialisation vector and generate the one-time symmetric key using the initialisation vector, the public session key and the processing device private key. The processing devices then encrypt a payload using the symmetric key to generate an encrypted payload and provide the response including the encrypted payload and the initialisation vector to the client application. The client application then generates the one-time symmetric key using the received initialisation vector, the private session key and the processing device public key and uses the one-time symmetric key to decrypt the encrypted payload.

Whilst any suitable encryption approach can be used, the above approach, which can be based on an anonymous key agreement protocol such as an Elliptic curve Diffie-Hellman (ECDH) protocol allows two parties to establish a shared key over an insecure channel. Furthermore, by repeating the key generation process for each message, this can be used to ensure a high degree of security is maintained.

The above described arrangement allows a wide range of functionality to be implemented by the processing device software, making this available to the client application, without necessarily requiring a high degree of complexity in the client application. In one preferred example, the processing device software is middleware, such as a middleware API, that interfaces with a payment system, such as a payment gateway or system of a payment service provider. This allows the processing device software to provide the client application with access to supported features of the payment system, whilst minimising complexity of the software and client application.

In one specific example, the above process can be implemented as a sequence of calls to the API, with the calls corresponding to functions of the underlying payment system. This allows functionality of the payment system to be accessed using a barebones client application, whilst allowing this to be performed in a manner that seeks to maintain security requirements. This in turn enables a host to rapidly implement a client application allowing payments, and in particular peer-to-peer payments, to be made using an existing payment system. In particular, largely default middleware and a client application can be provided including a number of supported features that leverage an existing payment infrastructure, allowing payments to be made, whilst achieving this in a secure manner.

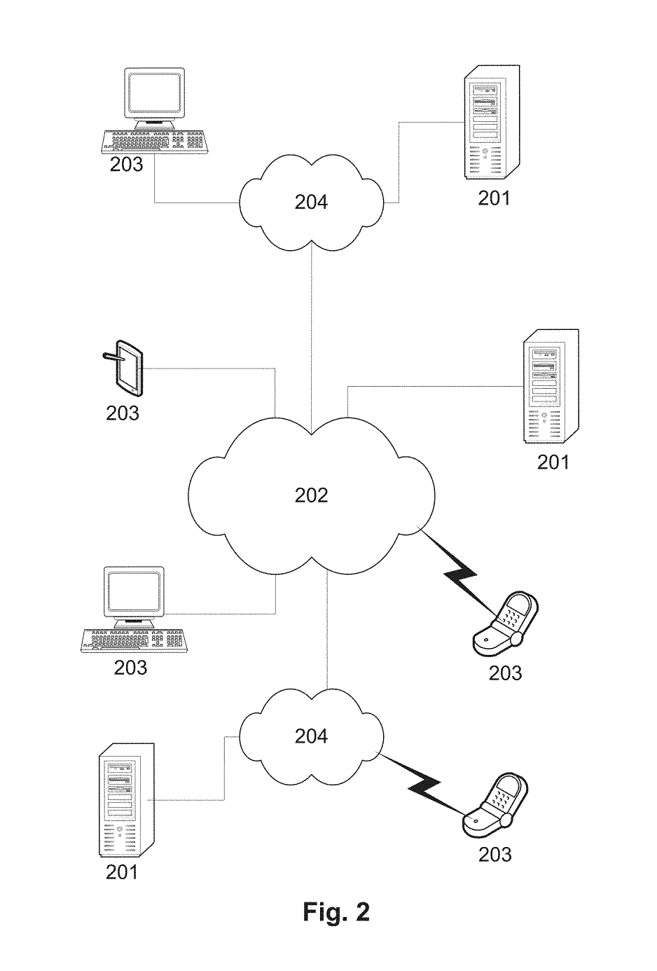

In one example, the process is performed by one or more processing systems operating as part of a distributed architecture, an example of which will now be described with reference to FIG. 2.

In this example, a number of base stations 201 are coupled via communications networks, such as the Internet 202, and/or a number of local area networks (LANs) 204, to a number of client devices 203. It will be appreciated that the configuration of the networks 202, 204 are for the purpose of example only, and in practice the base stations 201 and client devices 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, each base station 201 includes one or more processing systems 210, each of which may be coupled to one or more databases 211. The base station 201 is adapted to be used in receiving requests from and responding to the client devices. The client devices 203 are typically adapted to communicate with the base station 201, allowing requests to be made and responses received. The base station may also be adapted to implement payment services, or be connected to further payment systems (not shown), such as servers of financial institutions, payment gateways or the like, as will be appreciated by persons skilled in the art.

Whilst the base station 201 is a shown as a single entity, it will be appreciated that the base station 201 can be distributed over a number of geographically separate locations, for example by using processing systems 210 and/or databases 211 that are provided as part of a cloud based environment. However, the above described arrangement is not essential and other suitable configurations could be used.

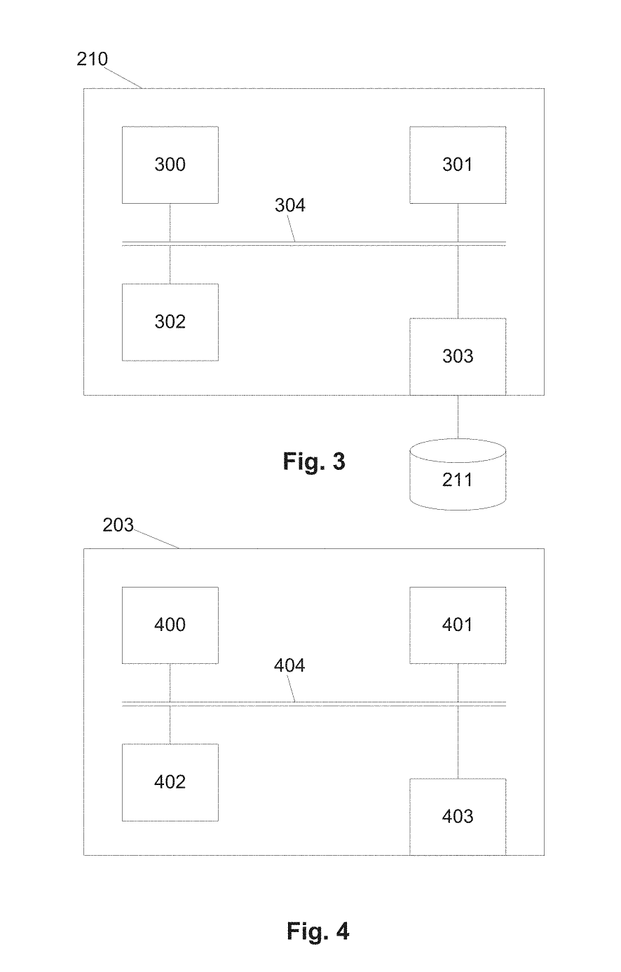

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed client device, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the client device 203 includes at least one microprocessor 400, a memory 401, an input/output device 402, such as a keyboard and/or display, and an external interface 403, interconnected via a bus 404 as shown. In this example the external interface 403 can be utilised for connecting the client device 203 to peripheral devices, such as the communications networks 202, 204, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401, and in particular including the client application, to allow communication with the base station 201.

Accordingly, it will be appreciated that the client devices 203 may be formed from any suitable processing system, such as a suitably programmed PC, Internet terminal, lap-top, or hand-held PC, and in one preferred example is either a tablet, or smart phone, or the like. Thus, in one example, the processing system 210 is a standard processing system, which executes software applications stored on non-volatile (e.g., hard disk) storage, although this is not essential. However, it will also be understood that the client devices 203 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for facilitating payments will now be described in further detail. For the purpose of these examples it is assumed that the one or more processing systems 210 act to receive requests, cause actions to be performed, and generate responses. The processing system 210 is therefore typically a server 210 (and will hereinafter be referred to as a server), which communicates with the client device 203 via a communications network, or the like, depending on the particular network infrastructure available.

To achieve this the server 210 of the base station 201 typically executes processing device software, which typically interfaces with an existing payment infrastructure, such as a banking system, payment gateway, or the like, allowing actions to be performed, as well as receiving requests from and providing responses to the client devices 203, with actions performed by the server 210 being performed by the processor 300 in accordance with instructions stored as applications software in the memory 301 and/or input commands received from a user via the I/O device 302, or commands received from the client device 203.

It will also be assumed that the user interacts with the server 210 via a GUI (Graphical User Interface), or the like presented on the client device 203, and in one particular example via an application that allows the user to view options and provide user inputs allowing requests to be generated. Actions performed by the client device 203 are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the client devices 203, and the base station 201 may vary, depending on the particular implementation.

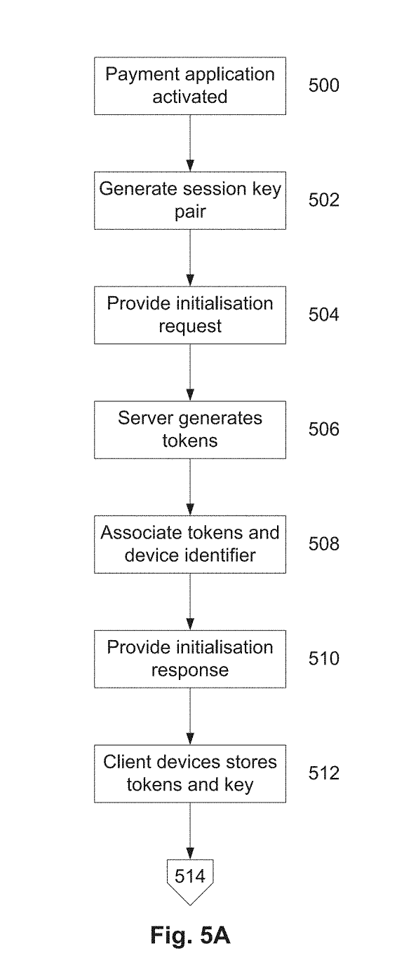

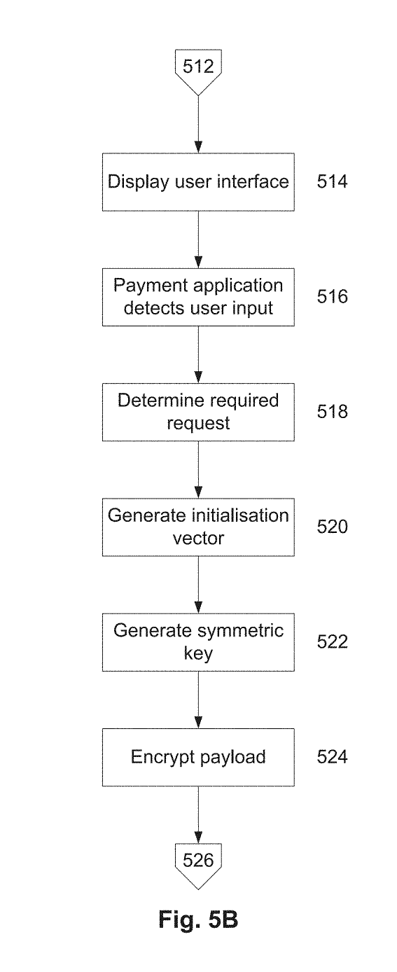

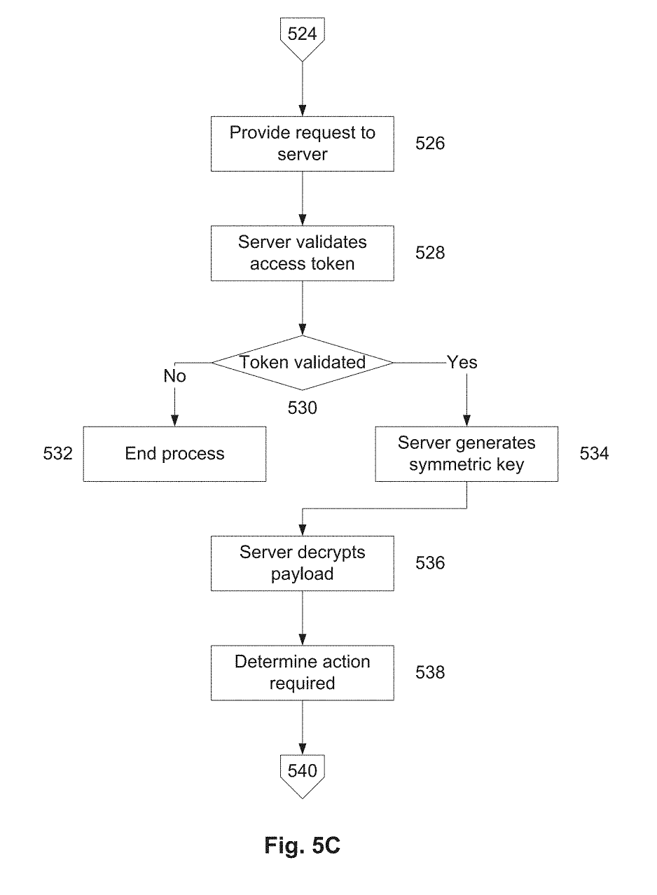

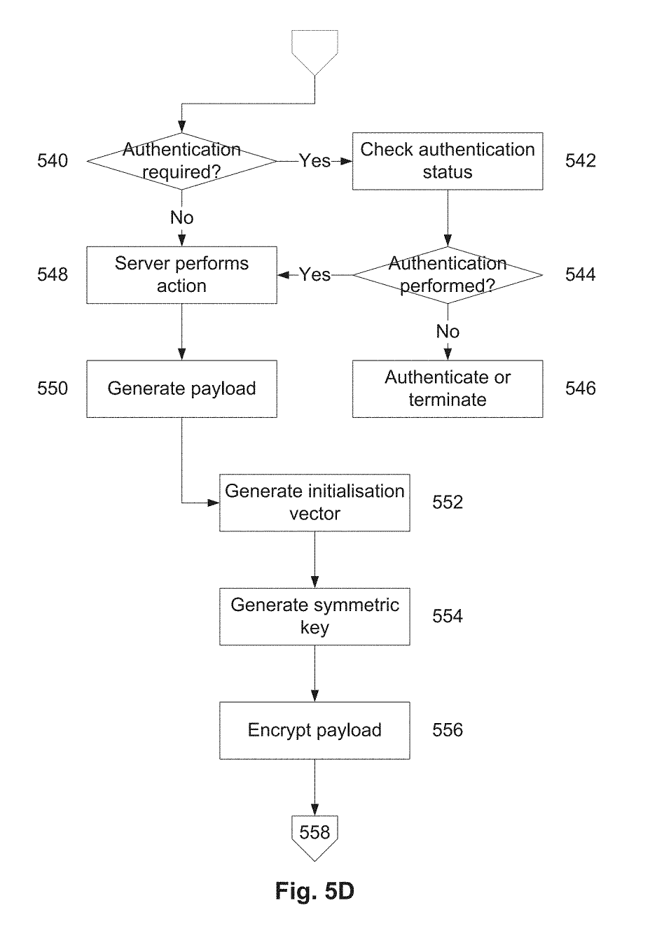

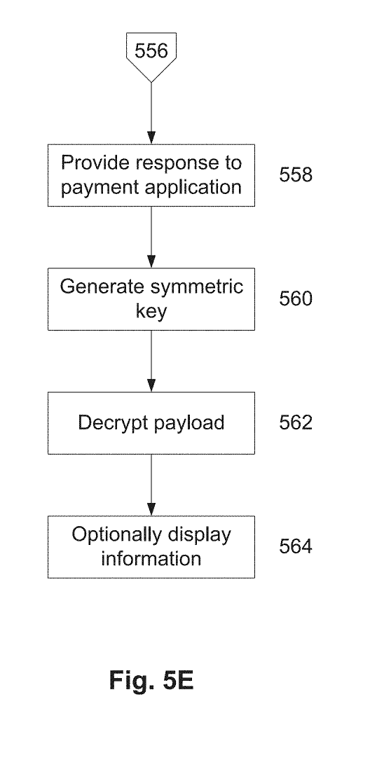

An example process of a process for facilitating a payment will now be described in more details with reference to FIGS. 5A to 5E.

In this example, at step 500 a user opens the client application on their respective client device 203, causing the client application to generate a session key pair at step 502. An initialisation request is generated and provided to the server 210 at step 504, with the initialisation request including a device identifier and a session public key of the session public/private key pair. The device identifier is indicative of an identity of the client device, and could include a hardware identifier, such as a MAC address, or another unique identifier assigned to the client device or the client application.

Having received the initialisation request, the server 210 generates access and refresh tokens at step 506, before recording an association between the tokens and the device identifier as part of session data at step 508. An initialisation response is then generated and provided to the client device 203 at step 510, the initialisation response including the access and refresh tokens, together with the server public key. The client device 203 stores the tokens and server public key at step 512, at which point the session is initialised and subsequent actions, such as payment processes can be performed.

The subsequent actions are performed using a series of calls to the server 210, with each call being formed from a request and corresponding response. The requests are generated to allow certain functionality made available by the server 210 to be requested and will be specific to the particular action being taken.

For example, once a session has commenced, the client application will typically be required to display a user interface to the user on the client device display at step 514. The manner in which this is achieved will vary depending on the preferred implementation, and this could include having the client application generate an initial “get interface” request, which causes the server 210 to provide a response defining how the interface should be rendered and the information to be displayed thereon.

However, for the purpose of illustration the following description will be generic without reference to any particular actions for simplicity. Nevertheless, it will be appreciated that functionality required to perform payments could be achieved by generating appropriate requests and having the server 210 perform appropriate actions and provide associated responses.

At step 516, the client application detects user input corresponding to selection of an option provided on the user interface, and uses this to determine a required request at step 518. As part of this process, the client application may display a prompt for any required information from the user.

At step 520, the client application generates an initialisation vector, for example, using a random number generator, and uses this together with the server public key and session private key to generate a one-time symmetric key at step 522.

In this regard, in the current example this is performed as part of a process such as Elliptic curve Diffie-Hellman (ECDH) encryption, which is an anonymous key agreement protocol that allows two parties, each having an elliptic curve public-private key pair, to establish a shared secret over an insecure channel. This shared secret may be directly used as a key, or to derive another key which can then be used to encrypt subsequent communications using a symmetric key cipher. It is a variant of the Diffie-Hellman protocol using elliptic curve cryptography.

At step 524, the one-time symmetric key is used to encrypt any payload data, such as user credentials, other sensitive data, user supplied information or the like, with a request being generated and transferred to the server 210 at step 526. In this regard, the request includes the encrypted payload, as well as the initialisation vector and the access token.

At step 528, the server 210 validates the access token, in particular by comparing this to the session data to confirm that the token corresponds to an access token issued by the server 210 to the respective client device, and that the access token has not expired. If it is determined that the token is not validated at step 530, then the process ends and the session is terminated at step 532. As part of this an exception or error message can be provided to the client device and displayed as required, allowing the process to restart if needed.

Otherwise, at step 534, the server 210 generates the same one-time symmetric encryption key using the initialisation vector, the public session key and the private server key, using this to decrypt any payload at step 536. The server 210 then determines any required actions at step 538 associated with the request.

If authentication has not been performed, only limited actions may be permitted, such as creating a new user, verifying a code, adding a PIN or creating an account. Assuming other actions are to be performed, authentication is typically required and accordingly the system operates to determine if authentication is required at step 540, for example depending on the action option selected by the user.

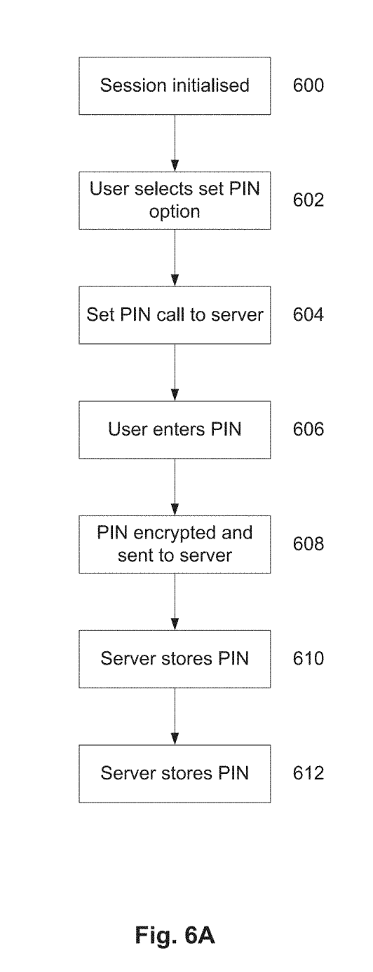

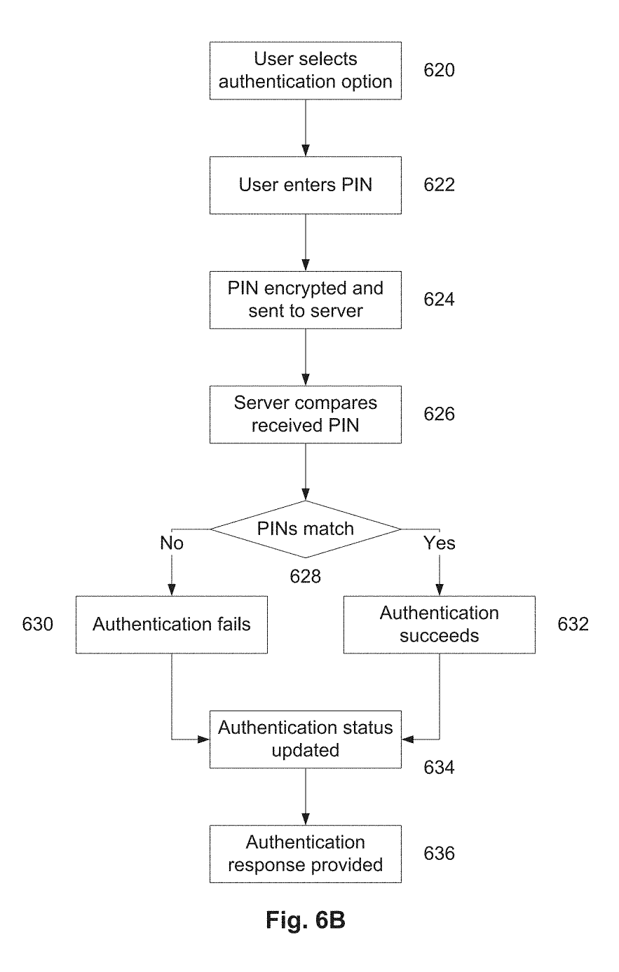

If it is determined that authentication is required, the server 210 checks an authentication status in the session data at step 542. In this regard, authentication is typically performed as part of a specific request and an example of this will be described in more detail with reference to FIGS. 6A and 6B. An authentication status is typically associated with the access token as part of the session data, and accordingly, the server 210 uses the received access token to determine the authentication status. If it is determined that authentication has not been performed at step 544, then the process typically redirects to allow authentication to be performed, or the process is halted at step 546.

In the event that authentication is not required, or if it is confirmed that authentication has been performed, the server 210 causes the relevant action to be performed at step 548. This will typically involve interfacing with other payment systems, for example a banking system, payment gateway or the like, and causing the actions to be performed, optionally in accordance with information provided by the user. For example, if the request corresponds to performing a payment, the user would typically be required to provide payment details, with these details being used to cause the payment to be performed.

At step 550, the server 210 generates a payload if required, optionally using information received from the payment system. The server 210 then generates an initialisation vector at step 552, using this to generate a new one-time symmetric key at step 554, which is in turn used to encrypt the response payload at step 556. The response is then provided to the client application at step 558, including the response initialisation vector and encrypted payload. This allows the client application to generate the symmetric key at step 560, decrypt the payload at step 562 and display information as required at step 564.

It will be appreciated that the above described process allows a sequence of requests and responses to be used to allow actions, and in particular payment actions to be performed. This can be driven by the processing device software, so that for example, the client application can submit a request for a list of actions that can be performed, and receive details of these as part of a response, allowing these to be displayed to a user. User inputs can then be used to determine user selection of a respective action, allowing the client application to generate a request that the respective action is performed. A response can be supplied requesting any required information, with this being supplied by via a further request. This minimises the amount of embedded processes required by the client application, in turn minimising the complexity. Nevertheless, it will be appreciated that in this manner, a sequence of requests and responses allows functionality embodied in the processing device software to be accessed by the client application. Consequently the client processing device software can be generic and requires little configuration, meaning this can be widely deployed by different service providers with minimal alteration.

As mentioned above, the process set out in FIGS. 5A to 5E is explained with reference to generic actions. Specific example of an authentication process implemented using the above described techniques will now be described with reference to FIGS. 6A and 6B.

In this example, the process involves having the user establish authentication information in the form of a PIN using the process shown in FIG. 6A.

At step 600, a session is initialised using the process outlined above with respect to steps 500 to 514. Once this has been performed, and a list of available actions displayed to the user, the user can select a set PIN option at step 620, causing a set PIN call to be made to the server at step 604. In this regard, the set PIN call will include a request sent to the server and a response from the server 210, which instructs the client application to display a prompt allowing the user to enter a PIN at step 606.

The PIN is encrypted using a one-time symmetric key, and sent to the server 210 as part of a request at step 608, allowing the server 210 to store the PIN as authentication data, typically associated with a user account or profile. In this regard, whilst the PIN can be stored in native form, more typically the PIN is secured using a one way encryption or hashing algorithm, thereby preventing third parties retrieving the PIN from the server 210, as will be appreciated by persons skilled in the art. A response confirming the PIN has been set is typically provided by the server 210 at step 612.

Once authentication information has been defined, this can be used in authenticating the user, and an example of the process for authenticating a user will now be described with reference to FIG. 6B.

In this example, it is assumed that a session has been initialised and a list of available actions displayed to the user, using the techniques previously described. At step 620, the user selects an authentication option (which may be triggered by selecting another option that in turn requires authentication), causing the client application to prompt the user to enter the PIN at step 622. The PIN is encrypted and sent to the server as part the payload of an authenticate PIN request at step 624, allowing the server 210 to decrypt the payload and compare the received PIN to the stored authentication data at step 626. It will be appreciated hat this might involve encrypting or hashing the received PIN using the same one way encryption or hashing algorithm used when storing the authentication data.

If it is determined that the PINs do not match at step 628, authentication fails at step 630, otherwise it succeeds at step 632. In either case, the authentication status is updated at step 634, by storing an indication of the authentication status associated with the access token for the current session, for example as part of the session data. An authentication response can then be provided to the client application at step 636, allowing this to be displayed to the user.

Accordingly, it will be appreciated from the above examples, that the client application and processing device software interact allowing payment actions to be performed, and whilst only authentication processes have been described in any detail, it will be appreciated that any actions associated with payments, and in particular peer-to-peer payments, could be performed in a similar manner.

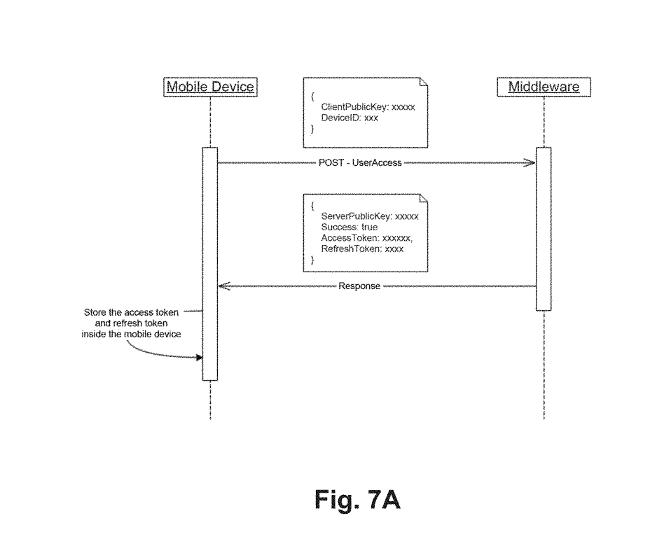

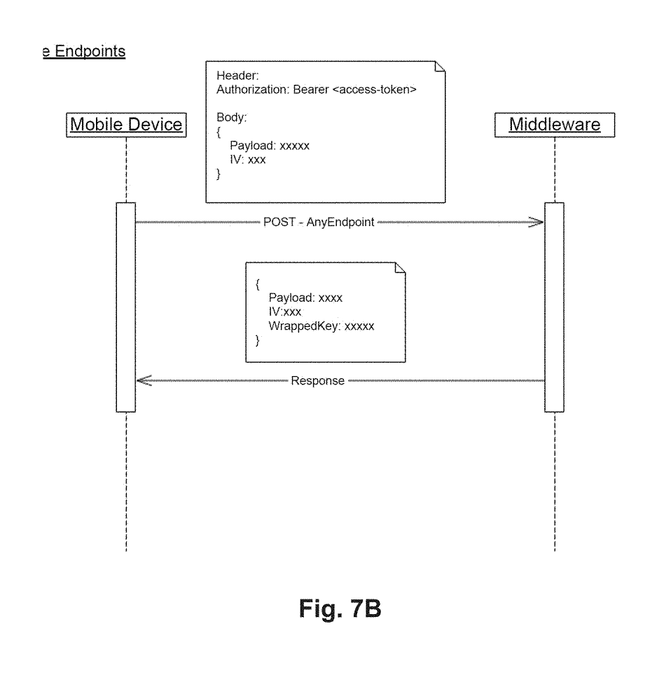

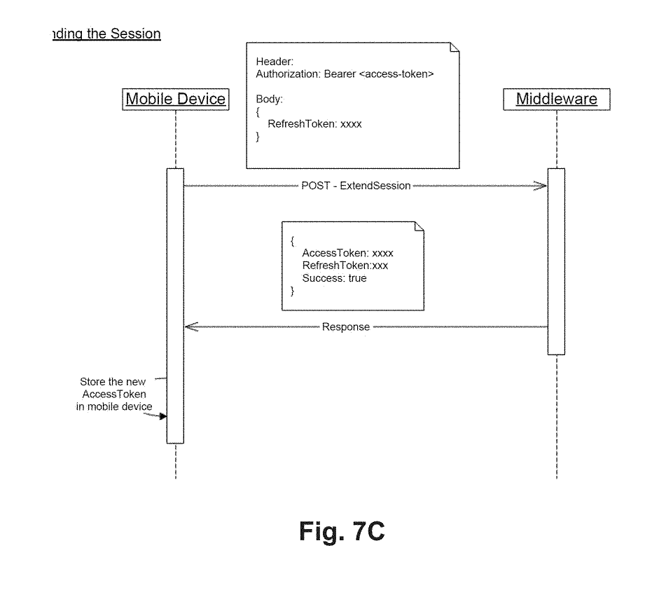

Further specific example processes for initialising a session, making calls using a token and refreshing an access token are shown in FIGS. 7A to 7C respectively. As these broadly follow the above approach these will not be described in any detail.

In any event, it will be appreciated that the above described arrangement allows payment processes to be implemented using a suitable architecture, including a client application and processing device software, which can in turn interface with existing payment systems. In one preferred example, the processing device software is middleware residing on a server or other similar processing system, which acts as an API allowing calls to be made from a mobile client application. The calls are processed, and used to cause actions to be performed by a backend payment system, that may be implemented by the server or another processing system.

In one particular example, this provides a client application requiring minimal functionality allowing this to be easily customised, for example through rebranding, allowing third parties to provide payment solutions, such as for peer-to-peer payments. Furthermore, the middleware can be easily configured to interface with any suitable payment system. This allows multiple service providers to provide peer-to-peer payment applications, through ere-use of easily configurable client applications and processing device software in the form of a middleware API.

Security for transaction is maintained using session specific keys generated by the client application for each new session. In general, encryption requirements for the requests and responses, are as outlined below:
All messages containing sensitive data, such as PII (Personally Identifiable Information) or PCI (Payment Card Industry) and authentication credentials is protected by message level encryption.
Authentication information, such as PINS, for the mobile client application should be stored in the middleware server and protected using an approved symmetric or hashing algorithm.
Cryptographic keys should not be stored on the client device which instead generates a new public/private key pair for every user session on the device. This key pair is used for the ECDH shared secret generation for message level encryption.
Cryptographic keys can be protected by a Hardware Security Module or Cryptography as a Service solutions.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A system for facilitating a payment using a client application executed by a client device, the system including one or more processing devices in communication with the client device via a communications network, wherein the one or more processing devices execute processing device software that cause the one or more processing devices to:
a) communicate with the client application to establish a transaction session having:
i) a session access token; and,
ii) a session key;
b) receive requests from the client application, at least some of the requests including the access token;
c) process the requests at least in part using the access token, to thereby allow at least one action to be performed, the at least one action forming part of a payment process; and,
d) provide any required response to the client application.

2. A system according to claim 1, wherein the requests from the client application further including an encrypted payload, the payload being encrypted at least in part using the session key.

3. A system according to claim 2, wherein the one or more processing devices execute processing device software that further cause the one or more processing devices to decrypt the payload at least in part using the session key.

4. A system according to claim 1, wherein the one or more processing devices:
a) receive a request;
b) validate the access token associated with the request; and
c) selectively perform actions in accordance with an outcome of the validation.

5. A system according to claim 1, wherein the one or more processing devices:
a) receive a session initiation request from the client application including:
i) a device identifier of the client device; and,
ii) a public session key generated by the client application;
b) generate an access token; and,
c) provide a session initiation response to the client application including a processing device public key and the access token.

6. A system according to claim 5, wherein the one or more processing devices store session data including an indication of the device identifier and the access token, and wherein the one or more processing devices validate the access token by comparing at least one of the access token and the device identifier associated with a request to the session data.

7. A system according to claim 5, wherein the one or more processing devices:
a) generate a refresh token; and,
b) provide a session initiation response including the refresh token,
wherein the client application:
c) determines if the access token has expired; and,
d) if the access token has expired, provides an access token request including a refresh token to the one or more processing devices, the one or more processing devices being responsive to the access token request to:
i) validate the refresh token;
ii) generate a new access token in accordance with an outcome of the validation; and,
iii) provide an access token response including the new access token to the client application.

8. A system according to claim 1, wherein the one or more processing devices:
a) determine if authentication has been performed;
b) selectively perform actions depending on an outcome of the determination;
c) receive an authentication request, the authentication request being generated by the client application at least partially in accordance with authentication information provided by a user; and,
d) selectively perform authentication using the authentication request.

9. A system according to claim 8, wherein the one or more processing devices perform authentication by comparing the authentication information to previously stored authentication information, and stores an indication of an authentication status associated with the access token.

10. A system according to claim 8, wherein the one or more processing devices:
a) determine the access token associated with a request; and,
b) determine if authentication has been performed at least partially in accordance with an authentication status associated with the access token.

11. A system according to claim 1, wherein the session key includes a public session and a private session key of a session key pair, the session key pair being generated for each transaction session by the client application.

12. A system according to claim 11, wherein each payload is encrypted and decrypted using a one-time symmetric key derived using the session key,
each one-time symmetric key being generated using:
a) an initialisation vector; and,
b) at least one of:
i) a private session key and a processing device public key;
ii) a public session key and a processing device private key.

13. A system according to claim 12, wherein the client application:
a) generates an initialisation vector;
b) generates a one-time symmetric key using the initialisation vector, the private session key and the processing device public key;
c) encrypts a payload using the symmetric key to generate an encrypted payload; and,
d) provides a request including the encrypted payload and the initialisation vector, and wherein the one or more processing devices are responsive to the request to:
i) generate the one-time symmetric key using the received initialisation vector, the public session key and the processing device private key; and,
ii) use the one-time symmetric key to decrypt the encrypted payload.

14. A system according to claim 12, wherein the one or more processing devices:
a) generate an initialisation vector;
b) generate the one-time symmetric key using the initialisation vector, the public session key and the processing device private key;
c) encrypt a payload using the symmetric key to generate an encrypted payload; and,
d) provide a response including the encrypted payload and the initialisation vector, the client application being responsive to the response to:
i) generate the one-time symmetric key using the received initialisation vector, the private session key and the processing device public key; and,
ii) use the one-time symmetric key to decrypt the encrypted payload.

15. A system according to claim 1, wherein the processing device software is middleware that interfaces with a payment system, and provides the client application with access to supported features of the payment system.

16. A system according to claim 15, wherein the payment system is at least one of:
a) a payment gateway; and,
b) a payment system implemented by a payment service provider.

17. A system according to claim 15, wherein the processing device software is an API to the payment system, and wherein the requests and responses correspond to API calls.

18. A system according to claim 1, wherein the system is used for making peer-to-peer payments.

19. A payment method for facilitating a payment using a client application executed by a client device and one or more processing devices in communication with the client device via a communications network, wherein the one or more processing devices execute processing device software, and wherein the method includes causing the one or more processing devices to:
a) communicate with the client application to establish a transaction session having:
i) a session access token; and,
ii) a session key;
b) receive requests from the client application, each request including
the access token;
c) process the requests to thereby allow at least one action to be performed in accordance with the requests, the at least one action including causing a payment to be performed; and,
d) provide any required response to the client application, each request including a payload encrypted at least in part using the session key.

20. A payment method according to claim 19, wherein the requests from the client application further including an encrypted payload, the payload being encrypted at least in part using the session key.

21. A payment method according to claim 20, further causing the one or more processing devices to decrypt the payload at least in part using the session key.
